(19) United States
(12) Patent Application Publication
(10) Pub. No.: US 2022/0317998 A1
(43) Pub. Date: Oct. 6, 2022

(54) METHOD AND SYSTEM FOR FACILITATING A UNIFIED DEVELOPMENT ENVIRONMENT TO INCREMENTALLY UPGRADE LEGACY SYSTEMS

(71) Applicant: Pardhasaradhi Jasti, Lakeway, TX (US)

(72) Inventor: Pardhasaradhi Jasti, Lakeway, TX (US)

(21) Appl. No.: 17/221,370

(22) Filed: Apr. 2, 2021

(51) Int. Cl. G06F 8/658; G06F 8/36; G06F 9/54; G06F 16/958; G06F 16/23; G06Q 50/26

(52) U.S. Cl. CPC G06F 8/658; G06F 8/36; G06F 9/542; G06F 16/972; G06F 16/2365; G06Q 50/26

(57) ABSTRACT

The present disclosure provides a method and system for facilitating a unified development environment to incrementally upgrade one or more legacy systems. Initially, a framework with a secure and open standard architecture is deployed on a plurality of legacy systems to provide a system-to-system integration among the plurality of legacy systems. The framework creates a seamless communication between at least one legacy system of the plurality of legacy systems and/or a plurality of new/upgraded legacy systems. A plurality of modules/applications of a web-based suite is integrated with the framework to compartmentalize the plurality of legacy systems and incrementally upgrade the one or more legacy systems.

### TECHNICAL FIELD

The presently disclosed subject matter generally relates to a method and system for facilitating a unified development environment to upgrade legacy systems. More specifically, the presently disclosed subject matter relates to compartmentalizing a plurality of legacy systems and incrementally upgrading the plurality of legacy systems for providing a modular single point integration system.

### BACKGROUND

In general, multiple public agencies across the country have their core systems running legacy code on a legacy infrastructure to meet existing customer demands. Legacy code and infrastructure make it difficult to implement new features or changes to existing features and functions. As a consequence, public agencies spend a lot of time and money to support old, complex systems.

Conventionally, some public agencies are trying to over haul core systems and some jurisdictions are trying to tackle the modernization efforts internally. However, both approaches do not provide satisfactory results, and jurisdictions are exploring intuitive options to succeed with modernization efforts.

The first approach of trying to over haul core systems is processed by selecting a large enterprise customer relationship management (CRM) platform to modernize the agency core systems. However, as multiple states/countries have discovered, the cloud-based CRM applications are expensive and were never meant to modernize the state agency core systems. Also, the cloud-based application only provides temporary solutions. So, to date agencies scramble to find ways to migrate out of the CRM platforms and identify a solution which can modernize the legacy systems.

Further, the second approach of preforming the modernization efforts internally requires a large and experienced digital transformation team which often is not available in state agencies. So, existing internal digital transformation teams create small migration projects to fulfil temporary needs. However, without a robust framework, the internal teams deliver small and simple applications that cannot scale or integrate with other desired/needed applications.

Therefore, in light of the above, there is a need for a method and system for providing cost-effective, trackable and focused upgrades to legacy systems and creation of a single point integration for modernizing the legacy systems.

### SUMMARY

In accordance with the present disclosure, various embodiments of the method and system for facilitating a unified development environment to upgrade legacy systems are disclosed. In one embodiment, the present disclosure provides a method for facilitating a unified development environment to incrementally upgrade one or more legacy systems, the method comprising the steps of: deploying a framework on a plurality of legacy systems to provide a system-to-system integration among the plurality of legacy systems, wherein the framework creates a seamless communication between at least one legacy system of the plurality of legacy systems and/or a plurality of new/upgraded legacy systems, and integrating a plurality of modules/applications of a web-based suite with the framework to compartmentalize the plurality of legacy systems and incrementally upgrade the at least one legacy system of the plurality of legacy systems, wherein the at least one legacy system of the plurality of legacy systems, or the plurality of modules/applications, is modernized by the upgrading.

In some embodiments, the presently disclosed method provides that a user may use the plurality of modules/applications of the web-based suite and the framework records a plurality of audit events based on a user's one or more actions and proactively generates one or more alerts to respective teams to notify an event, and wherein an event is selected from a group comprising an issue, fault, or outage related to a module hosted on the framework.

In some embodiments of the presently disclosed method, the framework comprises master data cleansing module for analysing master data in a batch process and for detecting abnormalities in the master data to prevent data corruption.

In some embodiments of the presently disclosed method, the plurality of modules/applications of the web-based suite provides incremental upgrades to the plurality of legacy systems to improve a user experience.

In some embodiments of the presently disclosed method, the plurality of modules/applications is selected from a group comprising vehicle registration, title transfer, driver testing, or voter registration.

In one embodiment, the present disclosure provides a system for facilitating a unified development environment to incrementally upgrade one or more legacy systems, the system comprising: a framework deployed on a plurality of legacy systems to provide a system-to-system integration among the plurality of legacy systems, wherein the framework establishes a seamless communication between at least one legacy system of the plurality of legacy systems and/or a plurality of new/upgraded legacy systems, and a plurality of modules/applications of a web-based suite integrated with the framework to compartmentalize the plurality of legacy systems and incrementally upgrade the at least one legacy system of the plurality of legacy systems, wherein the at least one legacy system of the plurality of legacy systems, and/or plurality of modules/applications, is modernized via the framework.

In some embodiments of the presently disclosed system, the framework provides a secure and open standard architecture for updating and integration of the plurality of legacy systems.

In some embodiments of the presently disclosed system, the system further comprises test data bots to provide users with required test data for training a plurality of teams in an agency or an organization which comprises the legacy system.

In some embodiments of the presently disclosed system, the agency or organization comprising the plurality of legacy systems is a department of motor vehicle (DMV).

In some embodiments of the presently disclosed system, the plurality of modules/applications of the web-based suite replace one or more modules of the plurality of legacy systems at a scheduled time.

In some embodiments of the presently disclosed system, the plurality of modules/applications of the web-based suite provides built-in performance reports to monitor and provide a 360-degree customer view for enhancing the user's experience.

In some embodiments of the presently disclosed system, the plurality of modules/applications of the web-based suite is integrated with the framework to incrementally modernize the DMV by upgrading or replacing the DMV legacy systems.

### BRIEF DESCRIPTION OF THE DRAWINGS

The accompanying drawings in which reference numerals refer to identical or functionally similar elements throughout the separate views and which together with the description herein are incorporated in and form part of the specification, serve to further illustrate various embodiments and to explain various principles and advantages all in accordance with the disclosed subject matter.

FIG. 1 schematically illustrates a system for facilitating a unified development environment to incrementally upgrade one or more legacy systems in accordance with an embodiment of the presently disclosed subject matter.

FIG. 2 schematically illustrates a framework to provide common modernized development environment for the one or more legacy systems in accordance with an embodiment of the presently disclosed subject matter.

FIG. 3 schematically illustrates a web-based suite specific to a department of motor vehicles (DMVs) to incrementally upgrade the one or more legacy systems in accordance with an embodiment of the presently disclosed subject matter.

FIG. 4 schematically illustrates an implementation approach of a web-based suite by integrating framework with a plurality of modules/applications to compartmentalize the one or more of legacy systems in accordance with an embodiment of the presently disclosed subject matter.

FIG. 5 schematically illustrates a service architecture of the web-based suite utilized to incrementally upgrade the one or more legacy systems in accordance with an embodiment of the presently disclosed subject matter.

FIG. 6 schematically illustrates a flow chart of a method for facilitating the unified development environment to incrementally upgrade the one or more legacy systems in accordance with an embodiment of the presently disclosed subject matter.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

Before describing in detail embodiments that are in accordance with the presently disclosed subject matter, it should be observed that the embodiments include primarily combinations of method steps and system components related to integration of a plurality of modules/applications of a web-based suite with a framework for incrementally upgrading one or more legacy systems in a cost-effective approach.

Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article or composition that comprises the element.

Various embodiments of the invention provide a method and system for facilitating a unified development environment to incrementally upgrade one or more legacy systems. To start with, a framework, such as a digital framework, with a secure and open standard architecture is deployed on a plurality of legacy systems to provide a system-to-system integration. Subsequently, the framework establishes a seamless communication between one or more of the plurality of legacy systems and/or a plurality of new/upgraded legacy systems. Moving on, the method and system integrates a plurality of modules/applications of a web-based suite with the framework to compartmentalize the plurality of legacy systems and incrementally upgrade the one or more legacy systems. The plurality of modules/applications are modernized utilizing the framework.

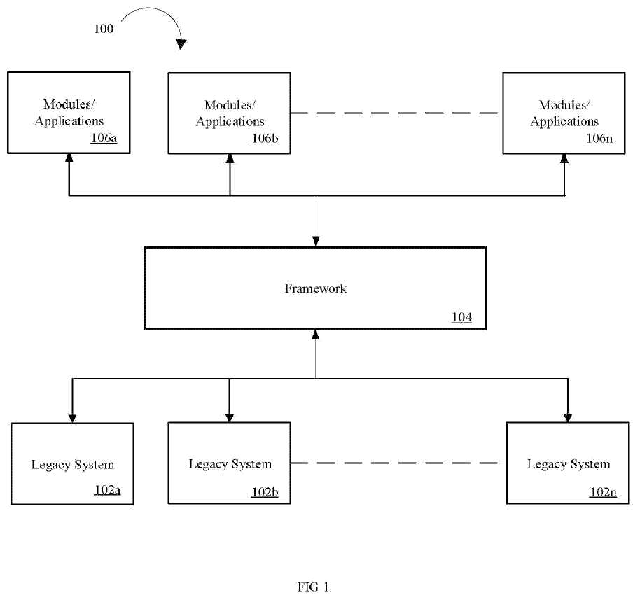

FIG. 1 illustrates a system 100 for facilitating a unified development environment to incrementally upgrade one or more legacy systems 102a, 102b . . . 102n in accordance with an embodiment of the invention.

As illustrated in FIG. 1, a framework 104 built with a secure and open standard architecture is deployed in communication with a plurality of legacy systems 102a, 102b . . . 102n which may be utilized by a plurality of public agencies or organizations such as, but not limited to, departments of motor vehicles (DMVs).

Framework 104 deployed in communication with the plurality of legacy systems 102a, 102b . . . 102n provides a system-to-system integration and creates a seamless communication between the one or more of the plurality of legacy system 102a, 102b . . . 102n and, possibly, a plurality of new or upgraded legacy systems.

New or upgraded legacy system may be legacy systems which were added to the deployment described above at a later time or legacy system which were part of the original deployment and which were upgraded.

For instance, if a legacy system 102a is upgraded utilizing framework 104, legacy system 102a can establish communication with other upgraded legacy systems and/or an original/older legacy system through framework 104.

In accordance with one example of the presently disclosed subject matter, framework 104 may a framework, also referred to herein as FactorX, which is specifically utilized to modernize DMVs, generally in a manner of a single step at a time, for rapid development and integration of plurality of legacy systems 102a, 102b . . . 102n.

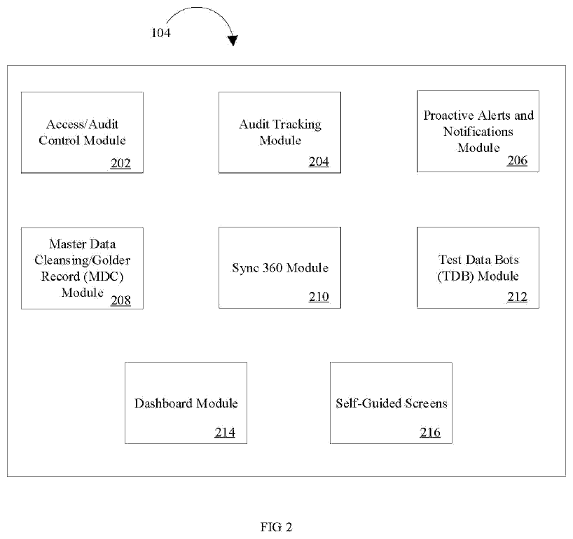

In one embodiment, framework 104 provides data synchronization options to seamlessly integrate with the plurality of legacy systems 102a, 102b . . . 102n, for example, of DMVs, for modernizing these legacy systems. Framework 104 is further detailed in conjunction with FIG. 2.

Moving on, a plurality of modules/applications 106a, 106b . . . 106n of a web-based suite is integrated with framework 104 to compartmentalize the plurality of legacy systems 102a, 102b . . . 102n and incrementally upgrade one or more of the legacy systems 102a, 102b . . . 102n.

Plurality of modules/applications 106a, 106b . . . 106n are modernized using framework 104 to improve an end user experience in accessing the plurality of public agencies or organizations. The term modernize/s as used herein comprises upgrading by software updates.

Additionally, plurality of modules/applications 106a, 106b . . . 106n can replace one or more existing modules configured with, or in conjunction with, the plurality of legacy systems 102a, 102b . . . 102n based on a desired/determined schedule.

Further, the plurality of modules/applications 106a, 106b . . . 106n provides a built-in performance monitoring and a 360-degree customer view for enhancing a customer's experience.

According to one example of the presently disclosed subject matter, the plurality of modules/applications 106a, 106b . . . 106n of the web-based suite is integrated with framework 104 to incrementally modernize DMVs and transform/improve the DMVs in an efficient manner.

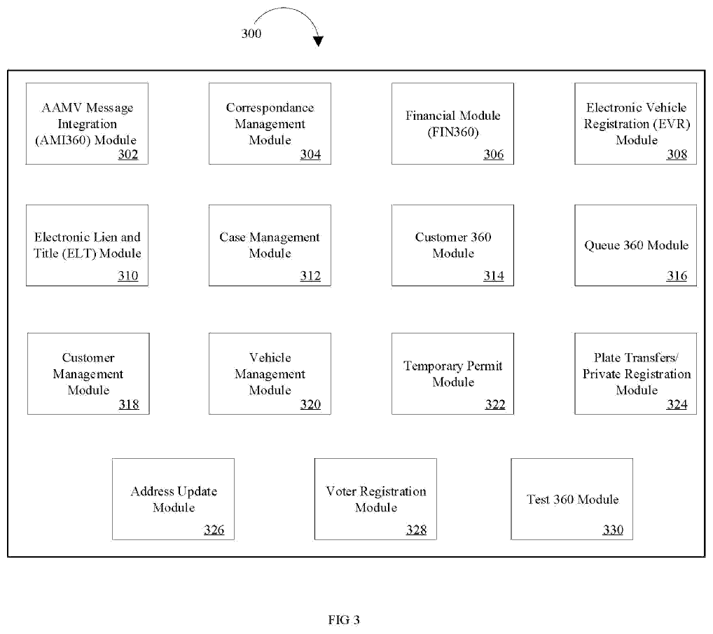

Further, plurality of modules/applications 106a, 106b . . . 106n of the web-based suite specific to DMVs is detailed in conjunction with FIG. 3.

FIG. 2 illustrates framework 104 designed to provide common modernized development environment for one or more legacy systems 102a, 102b . . . 102n in accordance with an embodiment of the invention.

As illustrated in FIG. 2, framework 104 provides a common/unified platform for rapid application development. Framework 104 includes an access control module 202 to provide an authentication and authorization for accessing modules.

Access control module 202 adopts up to date in the field security and open standard software to integrate with different types of authentication providers for providing access control to users. Access control module 202 also provides one or more common features which may include, but not limited to, file upload/payment gateway integration across all other modules.

Framework 104 also includes an audit tracking module 204 which analyses and tracks a user's activity related to sensitive and critical system information. User sensitive and critical system information comprises social security number, address, date of birth, or indeed any user information not publicly available, or preferable not to be made public. Further, all modules hosted on framework 104 are built to record audit events based on users one or more actions. The audit events are used to transmit proactive notifications to respective teams using a proactive alerts and notifications module 206.

The modules created which are part of framework 104 are designed to send heartbeat/real-time events' reports, where the reports are used to detect unexpected issues such as, but not limited to, faults, outages, and latency issues related to the modules, or their use. These reports are configured to transmit, or trigger transmission of, notifications to respective teams using proactive alerts and notifications module 206 to allow these teams to deal with the event, for example, to repair an outage before the service outage is experienced by the users.

Further, framework 104 includes a master data cleansing or golden record (MDC) module 208 to detect abnormalities occurring while entering master data, and make suggestions to users to prevent data corruption. An example of an abnormality which may be detected by module 208 is a typo introduced by a user when entering data manually. Detection of the typo by module 208 prevents it from transferring to other systems. Master data is generally a customer record which may include customers' data/information, driving record, licenses, etc. MDC module 208 generally uses a batch process to analyse master data and generate report with abnormalities on a scheduled basis.

Upon receiving the master data, sync 360 module 210 is used to synchronize the master data across different systems, such as applications/modules and/or legacy systems, by allowing instant data updates based on the users' activity. Thus, the process of synchronizing the data prevents duplicate data entries and reduces errors due to manual entry.

Moving on, framework 104 includes a test data bots (TDB) module 212 which is designed to provide users with required test data (preparation exercise for functional testing) for reducing the time spent on performing manual testing.

TDB module 212 is used to generate a demo data for training the users/staff in the public agencies or organizations after upgrading the legacy systems. TDB module 212 also relieve agencies with strict data compliance issues because it allows them be trained by the module 212 and thus avoid sharing production data with development teams and testing teams.

Further, every module created using framework 104, or which is part of framework 104, records users' activities to track and record the time taken by users for activities they performed, the type of activities they performed, and the records are used to create dashboards for each module using a dashboard module 214. Based on the data, dashboard module 214 generates management reports for the information gathered by each module. Management report provides, for example, operational information such as number of transactions generated, number of users, etc.

In addition, framework 104 provides self-guided screens 216, which allow users to complete transactions using plurality of modules/applications 106a, 106b . . . 106n.

FIG. 3 illustrates an example of a web-based suite 300 specific to a department of motor vehicles (DMVs) designed to incrementally upgrade the one or more legacy systems in accordance with an embodiment of the invention.

FIG. 3 features an example of a web-based suite 300 comprising a plurality of modules/applications generally represented by 106a, 106b . . . 106n in FIG. 1, and in FIG. 3 depicted by examples of specific function module/applications 302-330. The description herein of applications/modules 302-330 may apply to any module/application 106a, 106b . . . 106n of the system for facilitating a unified development environment to incrementally upgrade one or more legacy systems 100. The modules/applications 302-330 are integrated with, or in communication with, framework 104 to compartmentalize plurality of legacy systems 102a, 102b . . . 102n and incrementally upgrade one or more legacy systems 102a, 102b . . . 102n. The plurality of modules/applications 302-330 included in web-based suite 300 are optionally modernized using framework 104.

According to the embodiment of FIG. 3, web-based suite 300 includes an American association of motor vehicle administrators (AAMV) message integration (AMI360) module 302 designed to help jurisdictions to modernize and streamline the communication with AAMVA for vehicle related or credential related transactions. Essentially, AAMVA is a 3rd party data provider which provides information for DMV's. Different DMV systems use the information provided by AAMVA. Basically, instead of each DMV system working with the AAMVA API's, the current system connects to the AAMVA, derives information from it, and then provide this information to DMV systems. This prevents changes in AAMVA to affect all other DMV systems.

So, AMI360 module 302 allows jurisdictions to eliminate duplicate integration, or recordation of data, across multiple legacy systems and adopts future AAMVA API changes seamlessly without impacting the legacy systems of the DMVs.

Additionally, a correspondence management module 304 included in the web-based suite 300 is designed to provide enhanced reporting and message capabilities to and from jurisdictions. The correspondence management module 304 is integrated with existing legacy systems of DMVs and provides in place correspondence generation or batch file generation and printing. Generally, in place correspondence means overlaying correspondence/notifications functionality without changing functional modules.

Also, correspondence management module 304 provides a digital communication platform for jurisdictions to reduce traditional mail communication.

Further, web-based suite 300 includes a financial module (FIN360) 306 designed to support DMVs accounting for all financial transactions. Financial module 306 is used for statement management purposes and/or recording financial distributions.

Financial module 306 tracks transaction to cash activity and provides automated refunds and collection activities. Subsequently, financial module 306 includes robust auditing capabilities and generation of data reports.

Moving on, web-based suite 300 includes an Electronic Vehicle Registration (EVR) module 308 which is designed to allow jurisdictions to either extend their existing vehicle registration functionality to business partners or incrementally upgrade in-house existing registration system.

EVR module 308 provides easy and intuitive registration process along with auditing and tracing of data. EVR module 308 also includes dashboards and data cards for transaction of snapshot data, and allows the user to view the data in a trace mode.

Web-based suite 300 may also include an Electronic Lien and Title (ELT) module 310 which provides easy and seamless interaction between a lienholder and a jurisdiction's motor vehicle agency.

In accordance with desired jurisdictions' outcomes, ELT module 310 may reduce time delays in the exchanges process of the vehicle and improve data accuracy. Also, the ELT module 310 eliminates mailing and printing costs of the vehicle data, and improves auditing and tracing of the vehicle.

In accordance with desired lienholders' outcomes, ELT module 310 provides an intuitive and easy secure interface to reduce time taken to complete the transactions and avoid storage/management required for paperwork.

Web-based suite 300 includes a case management module 312 which allows jurisdictions to track every step of a case from beginning to end such as, but not limited to, tickets, hearings, and appeals. Case management module 312 allows jurisdictions to share cases with other agencies or entities to collaborate and track the case.

Customer 360 module 314 included in web-based suite 300 reduces physical interaction between jurisdictions and customers, and allows customers to perform self-help transactions easily without interacting with agencies.

Customer 360 module 314 provides customized notifications for customers and allows departments of public safety agencies to view customer snapshots.

Further, web-based suite 300 includes a queue 360 module 316 to reduce time spent by the customer in physical branches. Queue 360 module 316 helps customers to provide all the needed details/information upfront and also allows the customer to complete the payment before visiting the branch physically.

In another embodiment, Queue 360 module 316 may also be integrated with a plurality of appointment systems designed to generate and schedule an appointment and then allowing the user to complete the final transaction in person. By integration it is generally meant that data or information received by an application/device/module in the present system can be read/manipulated/recorded by other applications/devices/modules in the system. By integration/integrate it may also simply mean connect or digitally connect.

In addition, web-based suite 300 includes a customer management module 318 to allow state agencies to manage customer data in one place and allow jurisdictions to keep a golden record of the customer data to share with other agencies in a secure fashion, or in a secure environment. A golden record is the most accurate, complete and comprehensive representation of a master data

Customer management module 318 also stores audit details of any unauthorized access of the user and transmits notifications about any fictitious activities of the user to respective/applicable agencies. Customer management module 318 may also provide a proactive duplicate customer entry notification and allows a customer merging/linking feature to allow an organization's customer company acquisitions/mergers. For example, when a user enters new customer information, module 318 checks against existing customer master data to verify if that customer information already exists. The module compares a key fields, such as name, address, social security number, etc.

Web-based suite 300 includes a vehicle management module 320 to manage vehicle's master data and to allow jurisdictions to store the vehicle-related history, and thus provides a one stop shop for all motor vehicles in that jurisdiction.

Further, web-based suite 300 includes a temporary permit module 322 which allows users to apply for temporary permit of vehicles and allows agencies to issue temporary permit for vehicles.

Moving on, a plate transfers/private registration module 324 allows a user to register and apply for a title for the vehicles purchased from a private party, or when transferring ownership from family members. Plate transfers/private registration module 324 also allows jurisdictions to approve or reject the transactions.

Address update module 326 included in web-based suite 300 allows customers to request an update of address within the jurisdictions and provides an option to agencies in the jurisdiction to take control over the process of allowing or rejecting the request of the customer.

Further, voter registration module 328 allows customers to register/pre-register their voter information with a secretary of state agency.

Finally, web-based suite 300 includes a test 360 module 330 to allow jurisdictions to evaluate the customer's knowledge by creating written tests with dynamic questions and further, provides an option for the customer to appear for the practical tests. A person skilled in the art will appreciate that the modules/application described in FIG. 3 are merely examples and that the web-based suite may comprise any suitable and desired modules/applications.

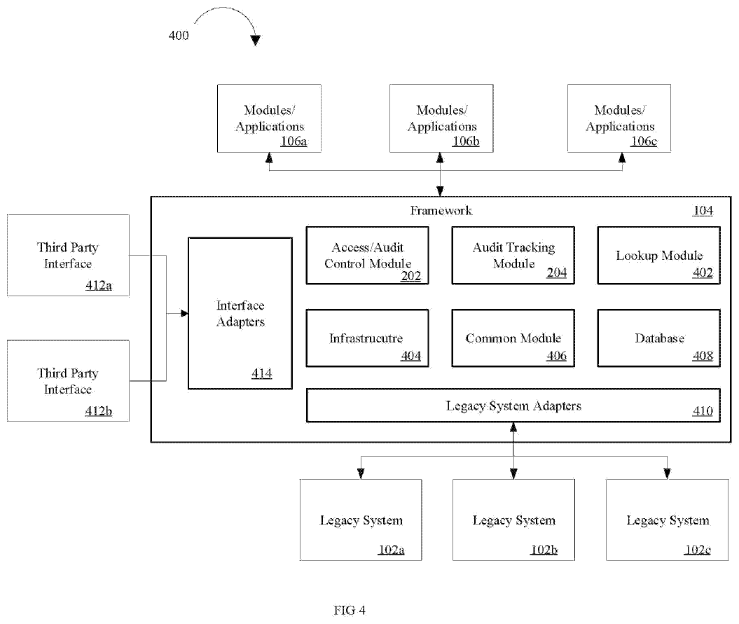

FIG. 4 illustrates an example of an implementation approach of the system 100 for facilitating a unified development environment to incrementally upgrade one or more legacy systems which integrates framework 104 with plurality of modules/applications 106a, 106b and 106c to compartmentalize the one or more of legacy systems.

As illustrated in FIG. 4, framework 104 is deployed on, or connected to, a plurality of legacy systems, in the example shown—102a, 102b, and 102c, to provide a system-to-system integration, and to create a seamless communication between the plurality of existing legacy systems 102a, 102b and 102c and a plurality of new or upgraded legacy systems.

Accordance to one embodiment, framework 104 includes access control module 202 which provides authentication and authorization for users in order access plurality of modules/applications 106a, 106b and 106c hosted on framework 104 by integrating with different types of authentication providers.

Upon authorizing the users, an audit tracking module 204 analyses and tracks a user's activity with sensitive and critical system information. Further, framework 104 records audit events based on users one or more actions and transmits a proactive notification to respective teams using proactive alerts and notifications module 206.

Further, lookup module 402 provides a synchronization of master data received from users across different systems and generates instant data updates based on the user's activity. This data synchronization prevents duplicate data entry and reduces errors due to manual entry.

Moving on, infrastructure 404 in framework 104 utilizes TDB module 212 which provides users (such as, jurisdiction workers) with required test data to reduce the time taken to perform manual testing. TDB module 212 generates a demo data for training a plurality of teams in various agencies and organizations. TDB module 212 can relieve agencies with strict data compliance issues to avoid sharing of production data with development teams and testing teams. In other words, when users do the testing, they need to prepare the test data so they can perform functional testing. Test data preparation takes time. The TDB 212 module generates test data so the user doesn't have to.

Finally, a common module 406 in framework 104 records the users activities to track the time taken by the user for performing the activities and record the types of activities performed by the user and based on the data gathered create dashboards for each module, and generates management reports for the information gathered by each module.

In addition, a plurality of actions/activities performed by the user on framework 104 is stored in a database 408. The plurality of actions/activities may include, but not limited to, data related to user activities, actions performed by the user, training demos, and the like.

Based on the plurality of actions performed by the user when accessing and using the plurality of modules/applications 106a, 106b and 106c of the DMVs, and the data gathered, framework 104 is integrates with plurality of modules/applications 106a, 106b and 106c to compartmentalize the plurality of legacy systems 102a, 102b and 102c and incrementally upgrade the one or more legacy systems using a legacy system adapter 414. It is noted that generally legacy systems are tightly coupled and one functional change might impact other areas. Compartmentalization generally means removing dependencies in between functional areas.

Upon upgrading the one or more legacy systems, framework 104 provides seamless communication between the plurality of legacy systems 102a, 102b and 102c.

In accordance with another embodiment, framework 104 allows the user to interact with plurality of modules/applications 106a, 106b and 106c using a plurality of third-party interfaces 412a and 412b.

Plurality of third-party interfaces 412a and 412b interacting with framework 104 communicates with plurality of modules/applications 106a, 106b and 106c via interface adapter 414.

Further, plurality of third-party interfaces 412a and 412b modernizes the usage of plurality of modules/applications 106a, 106b and 106c using framework 104 and upgrades the one or more legacy systems communicating with framework 104 via legacy system adapter 414.

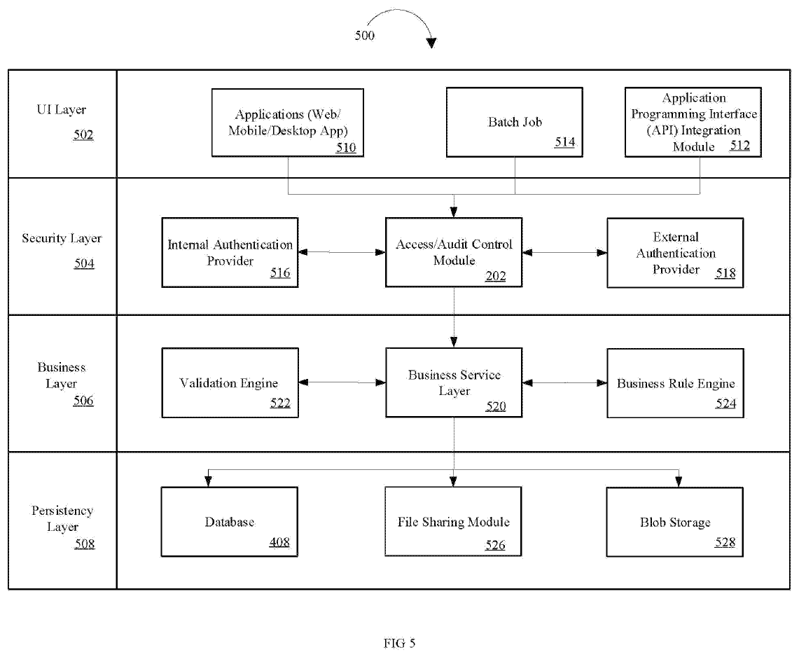

FIG. 5 illustrates an example of a service architecture 500 of the web-based suite 300 utilized to incrementally upgrade the one or more legacy systems in accordance with an embodiment of the presently disclosed subject matter.

As illustrated in FIG. 5, service architecture 500 of the web-based suite 300 includes a plurality of layers such as, a user interface (UI) layer 502, a security layer 504, a business layer 506, and a persistency layer 508.

UI layer 502 provides a communication venue to a user in order interact with the plurality of modules/applications 106a, 106b . . . 106n configured with, or connected to, legacy systems via applications/modules 510 configured on a device which may, include but need not be limited to, a web or a desktop or a mobile.

UI layer 502 includes an application programming interface (API) integration module 512 to establish communication between the application interface and other layers of the service architecture. Further, the task or actions performed by the user on UI layer 502 is processed as batch jobs 514 and further communicated with security layer 504.

Security layer 504 receives the plurality of actions performed by the user on UI layer 502 and authenticates the user using an access control module 516 in communication with an internal authentication provider 518 and an external authentication provider 520.

For instance, if the user is internal user and accessing plurality of modules/applications 106a, 106b . . . 106n which are already licensed, the user is authenticated using internal authentication provider 518 by directly providing a password in the application.

However, if the user is accessing plurality of modules/applications 106a, 106b . . . 106n via a third-party service provider, the user is authenticated using external authentication provider 520. Generally, internal user is a user accredited by the present applications/modules while an external user may be authenticated via other application registrations, for example, Azure active directory.

Upon authenticating the user at security layer 504, the user's details/information, or jobs performed by the user on UI layer 502, are forwarded to business layer 506 for further validation using a business service layer 522.

Business service layer 522 communicates with a validation engine 524 and a business rule engine 526 to validate the user details and job performed details before processing it further. Business rule engine 526 includes a predefined set of rules provided by application providers to execute the actions in runtime based on legal policies, company regulations, and the like.

Also, validation engine 524 employs a set of rules to validate the user in a authentication process to determine if to allow the user to access further details from persistency layer 508.

Once the user is validated, the user is allowed to access details from a database 528 storing a structured data related to the use and recorded data gathered from the plurality of modules/applications 106a, 106b . . . 106n.

Also, if required, the user is able to access data from a file sharing module 530 to access image or video data. Further, the user can also access data from a blob storage 532 for any data, or object related data, related to the use and recorded data gathered from plurality of modules/applications 106a, 106b . . . 106n.

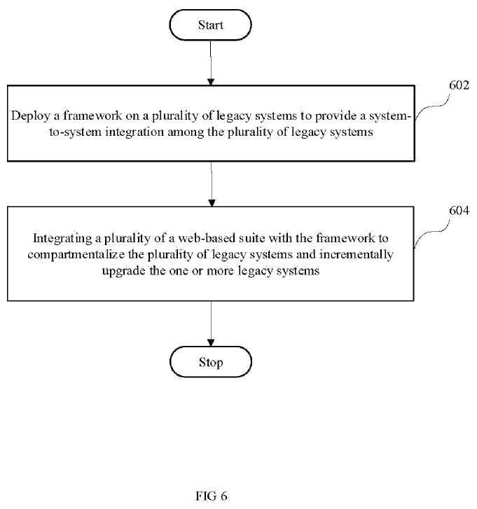

FIG. 6 illustrates an example of a flow chart of a method for facilitating the unified development environment to incrementally upgrade one or more legacy systems in accordance with an embodiment of the invention.

At step 602, framework 104 is deployed on plurality of legacy systems 102a, 102b . . . 102n to provide a system-to-system integration among plurality of legacy systems 102a, 102b . . . 102n.

Framework 104 comprises a secure and open standard architecture which creates a seamless communication between at least one of the pluralities of legacy systems and/or a plurality of new/upgraded legacy systems.

In an ensuing step 604, plurality of modules/applications 106a, 106b . . . 106n of a web-based suite are integrated with framework 104 to compartmentalize plurality of legacy systems 102a, 102b . . . 102n and incrementally upgrade the one or more legacy systems.

Further, plurality of modules/applications 106a, 106b . . . 106n are modernized by integrating framework 104.

The method and system for facilitating a unified development environment by integrating framework 104 and plurality of modules/applications 106a, 106b . . . 106n avoids high-risk in upgrading plurality of legacy systems 102a, 102b . . . 102n all-at-once using the ground-up modernization.

The presently disclosed method and system also avoids single vendor lock-in and can utilize best-in-class applications. Further, the method and system for integrating framework 104 and plurality of modules/applications 106a, 106b . . . 106n provides a cost-effective, trackable and focused upgrades of plurality of legacy systems 102a, 102b . . . 102n.

In an ensuing step, the present method and system quickly realizes return on investment (ROI) due to smaller and faster upgrades of plurality of legacy systems 102a, 102b . . . 102n.

The present method and system also lower project risk due to smaller and more manageable upgrades, and reduces operational risk due to fewer system disruptions.

Further, the present method and system spreads out project costs over a longer period as upgrades, where employees are not overwhelmed by sudden and massive technology change.

The present method and system for integrating framework 104 and plurality of modules/applications 106a, 106b . . . 106n creates a modular single point integration. The framework 104 used for integration can provide self-learning manuals and videos to the users for understanding the upgrade of one or more legacy systems.

Those skilled in the art will realize that the above recognized advantages and other advantages described herein are merely exemplary and are not meant to be a complete rendering of all of the advantages of the various embodiments of the invention. While many of the examples above featured services/upgrades applicable to DMVs, the presently disclosed system and method may be applied to any agency or organization comprising legacy systems.

The system, as described in the present disclosure, or any of its components, may be embodied in the form of a computing device. The computing device can be, for example, but not limited to, a general-purpose computer, a programmed microprocessor, a micro-controller, a peripheral integrated circuit element, and other devices or arrangements of devices, which can implement the steps that constitute the method of the invention. The computing device includes a processor, a memory, a non-volatile data storage, a display, and a user interface.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for facilitating a unified development environment to incrementally upgrade one or more legacy systems, the method comprising the steps of:
deploying a framework on a plurality of legacy systems to provide a system-to-system integration among the plurality of legacy systems, wherein the framework creates a seamless communication between at least one legacy system of the plurality of legacy systems and/or a plurality of new/upgraded legacy systems; and,
integrating a plurality of modules/applications of a web-based suite with the framework to compartmentalize the plurality of legacy systems and incrementally upgrade the one or more legacy systems, wherein the one or more legacy systems of the plurality of legacy systems is modernized by the upgrading.

2. The method according to claim 1, wherein a user may use the plurality of modules/applications of the web-based suite and the framework records a plurality of audit events based on a user's one or more actions and proactively generates one or more alerts to respective teams to notify an event, and wherein an event is selected from a group comprising an issue or outage related to a module hosted on the framework.

3. The method according to claim 1, wherein the framework comprises master data cleansing module for analyzing master data in a batch process and for detecting abnormalities in the master data to prevent data corruption.

4. The method according to claim 1, wherein the plurality of modules/applications of the web-based suite provides incremental upgrades to the plurality of legacy systems to improve a user experience.

5. The method according to claim 4, wherein the plurality of modules/applications is selected from a group comprising vehicle registration, title transfer, driver testing, or voter registration.

6. A system for facilitating a unified development environment to incrementally upgrade one or more legacy systems, the system comprising:
a framework deployed on a plurality of legacy systems to provide a system-to-system integration among the plurality of legacy systems, wherein the framework establishes a seamless communication between at least one legacy system of the plurality of legacy systems and/or a plurality of new/upgraded legacy systems; and
a plurality of modules/applications of a web-based suite integrated with the framework to compartmentalize the plurality of legacy systems and incrementally upgrade the plurality of legacy systems, wherein the plurality of legacy systems is modernized via the framework.

7. The system according to claim 6, wherein the framework provides a secure and open standard architecture for updating and integration of the plurality of legacy systems.

8. The system according to claim 6, further comprising test data bots to provide users with required test data for training a plurality of teams in an agency or an organization which comprises the legacy system.

9. The system according to claim 8, wherein the agency or organization comprising the plurality of legacy systems is a department of motor vehicle (DMV).

10. The system according to claim 6, wherein the plurality of modules/applications of the web-based suite replace one or more modules of the plurality of legacy systems at a scheduled time.

11. The system according to claim 6, wherein the plurality of modules/applications of the web-based suite provides built-in performance reports to monitor and provide a 360-degree customer view for enhancing the user's experience.

12. The system according to claim 9, wherein the plurality of modules/applications of the web-based suite is integrated with the framework to incrementally modernize the DMV by upgrading or replacing the DMV legacy systems.
